(19) United States
(12) Patent Application Publication
(10) Pub. No.: US 2023/0352854 A1
(43) Pub. Date: Nov. 2, 2023

(54) ANTENNA ASSEMBLY AND ELECTRONIC DEVICE

(71) Applicant: GUANGDONG OPPO MOBILE TELECOMMUNICATIONS CORP., LTD., Dongguan (CN)

(72) Inventor: Jianlin Wu, Dongguan (CN)

(21) Appl. No.: 18/142,076

(22) Filed: May 2, 2023

Related U.S. Application Data
(63) Continuation of application No. PCT/CN2021/116948, filed on Sep. 7, 2021.

(30) Foreign Application Priority Data
Nov. 2, 2020 (CN) 202011204405.9

(51) Int. Cl. H01Q 23/00; H01Q 1/38; H01Q 1/48

(52) U.S. Cl. CPC H01Q 23/00; H01Q 1/38; H01Q 1/48

(57) ABSTRACT

Provided are an antenna assembly and an electronic device. The antenna assembly includes a grounding plane, a first radiator, and a first signal source. A first gap is defined between the first radiator and the grounding plane. The first radiator includes a first radiation segment and a second radiation segment that are opposite to each other. A second gap is defined between the first radiation segment and the second radiation segment. The first radiation segment has a first feed point and a first ground terminal that are disposed thereon. The second radiation segment has a second ground terminal disposed thereon. The first signal source is connected to the first radiation segment at the first feed point.

### CROSS-REFERENCE TO RELATED APPLICATIONS

The present application is a continuation of International Application No. PCT/CN2021/116948, filed on Sep. 7, 2021, which claims a priority to Chinese Patent Application No. 202011204405.9, entitled “ANTENNA ASSEMBLY AND ELECTRONIC DEVICE”, and filed with China National Intellectual Property Administration on Nov. 2, 2020. The disclosures of the aforementioned applications are hereby incorporated by reference in their entireties.

### FIELD

The present disclosure relates to the technical field of electronic devices, and more particularly, to an antenna assembly and an electronic device.

### BACKGROUND

With the rapid development of communication technology, communication devices have become an indispensable tool in people's lives, and they have brought the users great convenience in all aspects of their lives. Generally, the communication device has a plurality of antennas disposed thereon. In particular, both the frequency bands and the number of antennas for a 5-th Generation Mobile Communication Technology (5G) device will become increasingly more in the future.

### SUMMARY

Embodiments of the present disclosure provide an antenna assembly and an electronic device, which can improve radiant performance of an antenna.

In a first aspect, embodiments of the present disclosure provide an antenna assembly. The antenna assembly includes a grounding plane, a first radiator, and a first signal source. The first radiator includes a first radiation segment and a second radiation segment that are opposite to each other. A first gap is defined between the first radiator and the grounding plane. A second gap is defined between the first radiation segment and the second radiation segment. The first radiation segment has a first feed point and a first ground terminal disposed on an end of the first radiation segment facing away from the second gap. The second radiation segment has a second ground terminal disposed on an end of the second radiation segment facing away from the second gap. The first signal source is connected to the first radiation segment at the first feed point and configured to feed an excitation signal to the first radiator. The excitation signal is configured to: excite a resonance of the first radiation segment in a first low-frequency mode, and excite a resonance of both the second radiation segment and the grounding plane in a second low-frequency mode.

In a second aspect, embodiments of the present disclosure further provide an electronic device. The electronic device includes a housing, and an antenna assembly located inside the housing. The antenna assembly includes a grounding plane, a first radiator, and a first signal source. The first radiator includes a first radiation segment and a second radiation segment that are opposite to each other. A first gap is defined between the first radiator and the grounding plane. A second gap is defined between the first radiation segment and the second radiation segment. The first radiation segment has a first feed point and a first ground terminal disposed on an end of the first radiation segment facing away from the second gap. The second radiation segment has a second ground terminal disposed on an end of the second radiation segment facing away from the second gap. The first signal source is connected to the first radiation segment at the first feed point and configured to feed an excitation signal to the first radiator. The excitation signal is configured to: excite a resonance of the first radiation segment in a first low-frequency mode, and excite a resonance of both the second radiation segment and the grounding plane in a second low-frequency mode.

### BRIEF DESCRIPTION OF THE DRAWINGS

In order to clearly explain technical solutions of embodiments of the present disclosure, drawings used in description of the embodiments will be briefly described below. Obviously, the drawings as described below are merely some embodiments of the present disclosure. Based on these drawings, other drawings can be obtained by those skilled in the art without creative effort.

FIG. 1 is a schematic structural diagram of an electronic device according to an embodiment of the present disclosure.

FIG. 2 is a schematic structural diagram of an antenna assembly according to an embodiment of the present disclosure.

FIG. 3 is a schematic diagram of a simulation of double resonances generated by an antenna assembly according to an embodiment of the present disclosure.

FIG. 4 is another schematic structural diagram of an antenna assembly according to an embodiment of the present disclosure.

FIG. 5 is yet another schematic structural diagram of an antenna assembly according to an embodiment of the present disclosure.

FIG. 6 is still yet another schematic structural diagram of an antenna assembly according to an embodiment of the present disclosure.

### DETAILED DESCRIPTION

Technical solutions according to embodiments of the present disclosure will be described clearly and thoroughly below in combination with accompanying drawings of the embodiments of the present disclosure. Obviously, the embodiments described below are only a part of the embodiments of the present disclosure, rather than all of the embodiments. Based on the embodiments in the present disclosure, all other embodiments obtained by a person skilled in the art without creative labor shall fall within the protection scope of the present disclosure.

In the description of the present disclosure, the terms “first” and “second” are only used for descriptive purposes, and they cannot be understood as indicating or implying relative importance or implicitly indicating the number of indicated technical features. Therefore, the features defined with “first” and “second” may explicitly or implicitly include at least one of the features. In the description of the present disclosure, “plurality of” means at least two, unless otherwise specifically defined.

In the present disclosure, it should be noted that, unless otherwise clearly specified and limited, terms such as “install”, “connect”, and “connect to” should be understood in a broad sense, for example, indicating a fixed connection or a detachable connection or connection as one piece; mechanical connection or electrical connection or mutual communication; direct connection or indirect connection via an intermediate; internal communication of two components or the interaction relationship between two components. Those skilled in the art can understand the specific meaning of the above-mentioned terms in the present disclosure based on the context.

The embodiments of the present disclosure provide a display screen assembly and an electronic device, which will be described in detail below. The display screen assembly may be disposed in the electronic device. The electronic device may be a smartphone, a tablet computer, and other devices.

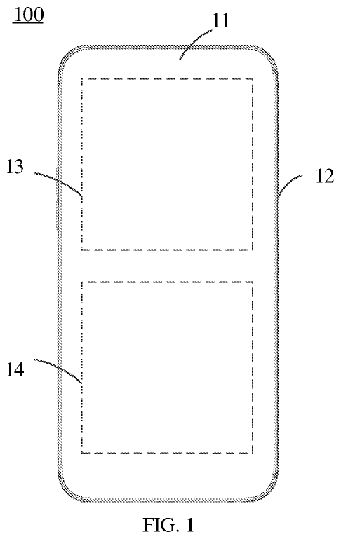

Reference may be made to FIG. 1, which is a first schematic structural diagram of an electronic device 100 according to an embodiment of the present disclosure.

The electronic device 100 includes a display screen 11, a housing 12, a circuit board 13, and a battery 14.

The display screen 11 is disposed on the housing 12 to define a display surface of the electronic device 100 for displaying information such as an image, a text, etc. The display screen 11 may include, for example, a Liquid Crystal Display (LCD) screen or an Organic Light-Emitting Diode (OLED) display screen.

A cover plate may also be mounted on the display screen 11 to cover the display screen 11. The cover plate may be a transparent glass cover plate, which allows the display screen to transmit light through the cover plat for display. In some embodiments, the cover plate may be a glass cover plate made of a material such as a sapphire.

The display screen 11 may has a display region and a non-display region. The display region may be configured to display pictures of the electronic device 100 or configured for touch control by a user, etc. The non-display region has an opening defined on a top region thereof to transmit sound and light, and functional components such as a fingerprint module and a touch button may be disposed on a bottom of the non-display region.

It should be noted that the display screen 11 is not limited to such a structure. For example, the display screen 11 may be a full screen or an irregular screen. It should also be noted that, in some embodiments, the display screen 11 may be designed into a full screen structure without providing the non-display region, and functional components such as a distance sensor and an ambient light sensor may be disposed below the display screen or at other positions. The cover plate is dimensioned to fit a size of the display screen.

The housing 12 is configured to define an outer contour of the electronic device 100, for accommodating electronic components, functional components, or the like of the electronic device 100, and the housing 12 is further configured to provide sealing and protection for the electronic components, the functional components, or the like in the electronic device. For example, the functional components of the electronic device 100, for example, a camera, a circuit board, and a vibration motor, may be disposed in the housing 12.

The housing 12 may include a middle frame and a rear cover. The middle frame and the rear cover are assembled with each other to form the housing 12, and they may define a receiving space for receiving the circuit board 13, the display screen 11, the battery 14, etc. Further, the cover plate may be fixed to the housing 12, and an enclosed space is defined by the cover plate and the housing 12 to accommodate the circuit board 13, the display screen 11, the battery 14, etc. In some embodiments, the cover plate is disposed to cover the middle frame in such a manner that the cover plate and the rear cover are located on opposite surfaces of the middle frame and opposite to each other.

In some embodiments, the housing 12 may be a metallic housing. For example, the housing 12 may be made of magnesium alloy, stainless steel, or other metallic materials. It should be noted that the material of the housing 12 according to the embodiments of the present disclosure is not limited to these metallic materials, and may be other materials. As an example, the housing 12 may be a plastic housing. As another example, the housing 12 may be a ceramic housing. As yet another example, the housing 12 may include a plastic part and a metallic part. The housing 12 may have a housing structure in which the metallic part and the plastic part cooperate with each other. In some embodiments, the metallic part may first be molded. For example, a magnesium alloy substrate may be first formed using injection molding, and a plastic substrate is then formed on the magnesium alloy substrate through injection molding of plastic, thereby forming a complete housing structure.

The circuit board 13 is disposed inside the housing 12. The circuit board 13 may be a main board of the electronic device 100. Further, the circuit board 13 may also be integrated with one or more functional components such as a processor, a camera, an earphone interface, an acceleration sensor, a gyroscope, or a motor. Meanwhile, the display screen 11 may be electrically connected to the circuit board 13, thereby controlling display of the display screen 11 via a processor on the circuit board 13.

In some embodiments, the circuit board 13 may be fixed in the housing 12. In some embodiments, the circuit board 13 may be screwed to the middle frame via screws, or the circuit board 13 may be fitted with the middle frame by means of a snap-fit. It should be noted that a specific manner to fix the circuit board 13 of the embodiments of the present disclosure to the middle frame is not limited to any of these examples and may be any other manners, such as a joint fixation of the snap-fit and the screw.

The battery 14 is disposed inside the housing 12. Meanwhile, the battery 14 is electrically connected to the circuit board 13 to supply power to the electronic device 100. The circuit board 13 may have a power management circuit disposed thereon. The power management circuit is configured to distribute a voltage provided by the battery 14 to each electronic component in the electronic device 100.

The electronic device 100 further has an antenna assembly 200 disposed thereon. The antenna assembly 200 is configured to realize a wireless communication function of the electronic device 100. The antenna assembly 200 is disposed inside a housing 20 of the electronic device 100. It should be understood that some components of the antenna assembly 200 may be integrated on the circuit board 13 inside the housing 12. For example, a signal processing chip and a signal processing circuit of the antenna assembly 200 may be integrated on the circuit board 13. In addition, some components of the antenna assembly 200 may also be directly disposed inside the housing 12. For example, an antenna of the antenna assembly 200 may be directly disposed inside the housing 12.

In the related art, with the evolution of network devices from 4-th Generation Mobile Communication Technology (4G) to 5-th Generation Mobile Communication Technology (5G) and with the increasing access condition restrictions of operators, a 5G antenna design is increasingly more complex, especially considering the operators' requirements in different countries for LB+LB EUTRA-NR Dual Connectivity (ENDC) combinations, e.g., B20+N28, B28+N5, B20+N8, etc. However, the above ENDC combinations can be only supported by at least three LB antennas, one of which is provided for a Long-Term Evolution (LTE) main network, and the other two of which are provided for New Radio (NR) antennas. Since an LB antenna requires a large space (a slit length of more than 30 mm), a layout of three LB antennas may lead to a more complex and compact antenna layout of the entire device under a current clearance size limit for a high screen-to-body ratio of the electronic device, and lead to a greater mutual coupling between the antennas. Also, the providers in the industry do not have a mobile phone solution for supporting LB+LB ENDC currently.

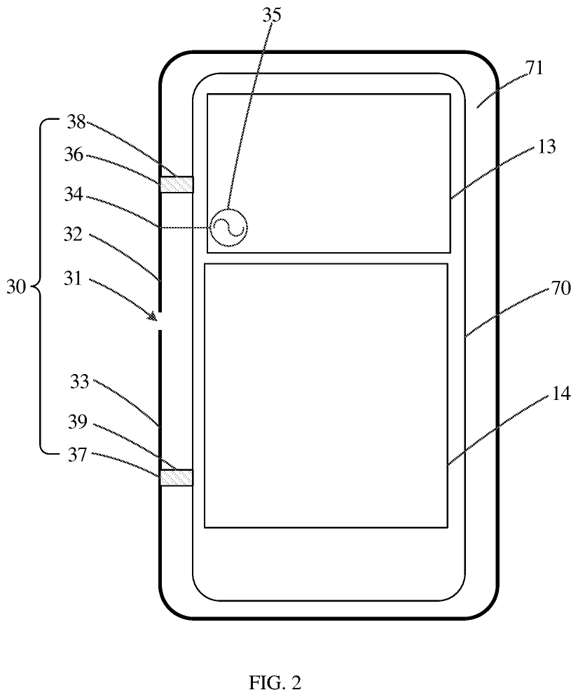

FIG. 2 is a first schematic structural diagram of an antenna assembly according to an embodiment of the present disclosure. Referring to FIG. 2, the antenna assembly 100 may include a grounding plane 70, a first radiator 30, and a first signal source 35. In some embodiments, a first gap 71 is defined between the first radiator 30 and the grounding plane 70. The first radiator 30 include a first radiation segment 32 and a second radiation segment 33 that are opposite to each other. A second gap 31 is defined between the first radiation segment 32 and the second radiation segment 33. The first radiation segment 32 has a first feed point 34 disposed thereon and a first ground terminal 36 disposed on an end thereof facing away from the second gap 31. The second radiation segment 33 has a second ground terminal 37 disposed on an end thereof facing away from the second gap 31. The first signal source 35 is connected to the first radiation segment 32 at the first feed point 34, and the first signal source 35 is configured to feed an excitation signal to the first radiator 30. The excitation signal is configured to: excite a resonance of the first radiation segment 32 in a first low-frequency mode, and excite a resonance of both the second radiation segment 33 and the grounding plane 70 in a second low-frequency mode.

Further, in embodiments of the present disclosure, a distance between the first feed point 34 and the second gap 31 is greater than a distance between the first feed point 34 and the first ground terminal 36. That is, a position of the first feed point 34 is closer to the first ground terminal 36 than the second gap 31.

In the embodiments, the second gap 31 is located between the first radiation segment 32 and the second radiation segment 33. The second gap 31 may be filled with air, or a non-conductive material, commonly a medium such as plastic. The second gap 31 between the first radiation segment 32 and the second radiation segment 33 is equivalent to a coupling capacitance, a size of which is mainly related to an area of an end surface of the first radiation segment 32 and the second radiation segment 33, a width of the second gap 31, and the medium filling in the second gap 31. By filling the second gap 31 with the non-conductive material, a structural strength of the antenna structure can be increased, and the antenna structure can have a good appearance. For example, the width of the second gap 31 may be smaller than 1 mm.

In an embodiment, further referring to FIG. 2, the antenna assembly further includes a circuit board 13, a first connection member 38, and a second connection member 39. The first signal source 35 is disposed on the circuit board 13. The first radiation segment 32 is coupled to the grounding plane 70 at a position of the first ground terminal 36 via the first connection member 38 for grounding. The second radiation segment 33 is coupled to the grounding plane 70 at a position of the second ground terminal 37 via the second connection member 39 for grounding.

The above-mentioned first connection member 38 and second connection member 39 may each be a flake-like metal. For example, each of the first connection member 38 and the second connection member 39 may be a magnesium alloy flake, an aluminum alloy flake, etc. The first connection member 38 and the second connection member 39 are disposed at the ground terminal of the first radiation segment 32 and the ground terminal of the second radiation segment 33, respectively, and coupled to the grounding plane 70. For example, when a metallic frame is used as the first radiator, the first connection member 38 and the second connection member 39 may be attached to the metallic frame of the electronic device, such that the first connection member 38 and the second connection member 39 are coupled to the metallic frame. Through the coupling, an electrical signal can be transmitted between the first connection member 38 and the metallic frame and between the second connection member 39 and the metallic frame.

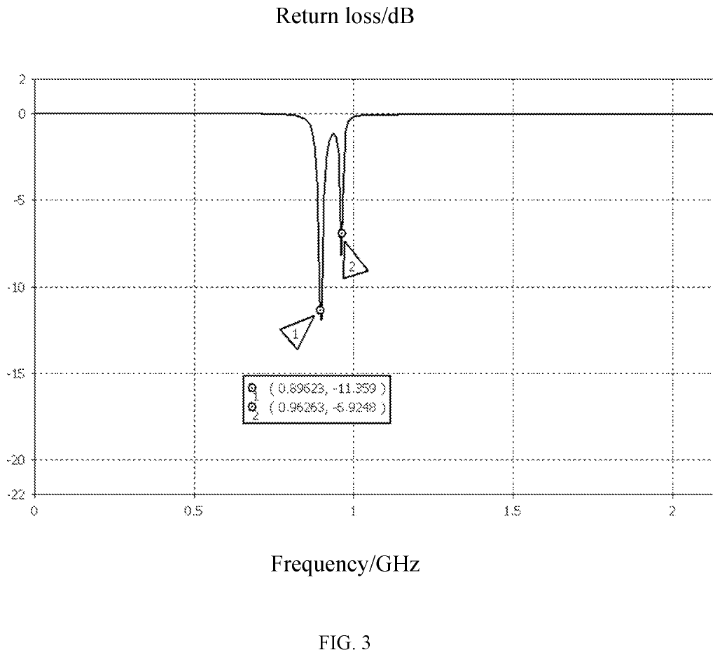

In the embodiments of the present disclosure, the above antenna assembly is configured to simultaneously generate a first resonance and a second resonance in two low-frequency bands. In some embodiments, the first signal source 35 is configured to feed an excitation signal to the first radiator 30. The excitation signal is configured to: excite a resonance of the first radiation segment 32 in a first low-frequency mode, and excite a resonance of both the second radiation segment 33 and the grounding plane 70 in a second low-frequency mode. FIG. 3 is a schematic diagram of a simulation of double resonances generated by an antenna assembly according to an embodiment of the present disclosure. As illustrated in FIG. 3, the above-mentioned first low-frequency mode is an inverted-F antenna resonance mode, and the above-mentioned second low-frequency mode is a loop antenna mode.

Further, in order to improve antenna performance, each of the first radiation segment 32 and the second radiation segment 33 may have a length greater than 30 mm.

In the embodiments, neither the first radiation segment 32 nor the second radiation segment 33 is required to be connected to an additional a ground branch, and grounding can be realized simply through the single ground terminal of each of the first radiation segment 32 and the second radiation segment 33 and the connection member. For double resonances generated by the above first radiator 30, one of the double resonances is generated by the first radiation segment 32, and the other one is generated by the second radiation segment 33. In some embodiments, the first resonance is generated by an excitation of the first signal source 35 through a path via the first radiation segment 32 and the first connection member 38, and the second resonance is generated by an excitation of the first signal source 35 through a path via the circuit board 13 adjacent to the first radiator 30, the second connection member 39, and the second radiation segment 33.

In some embodiments, the second low-frequency mode is generated by an electric field excitation at an end of the first radiation segment 32 close to the second gap 31. In addition, in a current path in the second low-frequency mode, a current is oriented to flow from the second ground terminal 37 to the second gap 31 through the second radiation segment 33. The current flows from the second ground terminal 37 to the second gap 31 is due to the reason that a current at a tail end of the first radiation segment 32 is the smallest, and a current at a ground position of the second radiation segment 33, i.e., the second ground terminal 37, is the largest.

It should be noted that the grounding plane 70 may be construed as a reference ground for the entire device. The first ground terminal 36 and the second ground terminal 37 may also be fixedly connected to the reference ground of the entire device through welding or through screwing and locking by means of a screw. In other embodiments, the first ground terminal 36 and the second ground terminal 37 may also be connected to the reference ground of the entire device via a connection wire. The present disclosure is not limited in this regard.

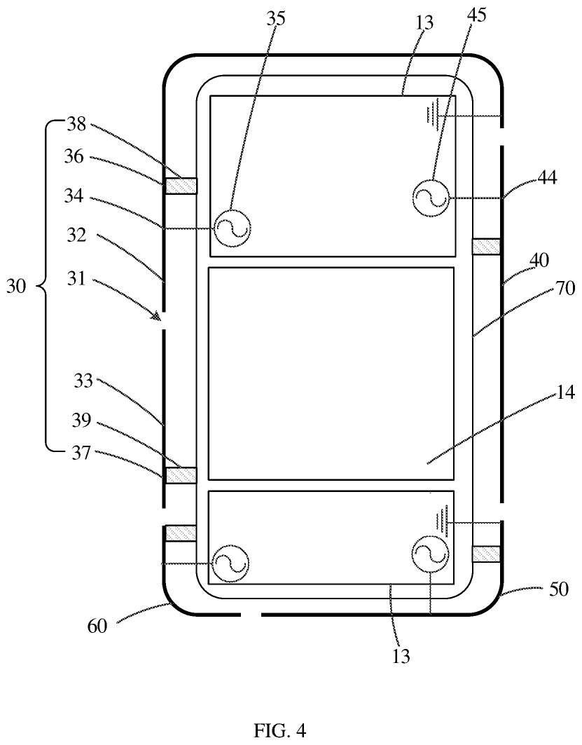

Further, with reference to FIG. 4, in this embodiment, the above antenna assembly may further include a second radiator 40.

The second radiator 40 has a second feed point 44. The second feed point 44 is configured to be connected to a second signal source 45. The second radiator is connected to the grounding plane 70 via a third connection member.

Further, in this embodiment, the first radiator 30 may be configured to transmit and receive a first low-frequency radio-frequency signal, and the second radiator 40 may be configured to receive a second low-frequency radio-frequency signal. The first radiation segment 32 of the first radiator 30 may be configured to transmit and receive a 4G radio-frequency signal. The second radiation segment 33 of the first radiator 30 may be configured to transmit and receive a 5G radio-frequency signal. The second radiator 40 may be configured to receive the 4G radio-frequency signal and the 5G radio-frequency signal. For example, the first low-frequency mode is configured to support the transmission and reception of the 4G radio-frequency signal, the second low-frequency mode is configured to support the transmission and reception of the 5G radio-frequency signal, and a third low-frequency mode excited by the second signal resource and the second radiator is configured to support the reception of the 4G radio-frequency signal and the 5G radio-frequency signal. Accordingly, the first low-frequency mode, the second low-frequency mode and the third low-frequency mode are configured to support LB+LB ENDC combination of 4G and 5G communication. The frequency bands of the above-mentioned 4G radio-frequency signal may include B1, B2, B3, B4, B5, B6, B7, B8, B9, B12, B17, B18, B19, B20, B26, and B28, etc., and the frequency bands of the above-mentioned 5G radio-frequency signal may include N1, N3, N5, N8, N28, N77, N78, and N79, etc. In this embodiment, a dual connectivity is formed by the first radiator and the second radiator to achieve an LB+LB ENDC combination, such as B20+N28, B28+N5, and B20+N8, etc.

In other embodiments, the first radiation segment 32 of the first radiator 30 may be configured to transmit and receive the 5G radio-frequency signal, the second radiation segment 33 of the first radiator 30 may be configured to transmit and receive the 4G radio-frequency signal, and the second radiator 40 may be configured to receive the 4G radio-frequency signal and the 5G radio-frequency signal. It should be noted that functions of the first radiation segment 32 and second radiation segment 33 of the first radiator 30 and the second radiator 40 can be adjusted as desired.

In an embodiment, the above antenna assembly may further include a third radiator 50.

The third radiator 50 has a third feed point 54. The third feed point 54 is configured to be connected to a third signal source 55. The third radiator 50 is connected to the grounding plane 70 via a fourth connection member.

Further, in this embodiment, the first radiator 30 may be configured to transmit and receive the first low-frequency radio-frequency signal; the second radiator 40 may be configured to transmit and receive the second low-frequency radio-frequency signal; and the third radiator 50 may be configured to transmit and receive a third low-frequency radio-frequency signal. The first radiation segment 32 of the first radiator 30 is configured to transmit and receive the 4G radio-frequency signal. The second radiation segment 33 of the first radiator 30 is configured to transmit and receive the 5G radio-frequency signal. The third radiator 50 is configured to receive the 4G radio-frequency signal and the 5G radio-frequency signal. In this embodiment, a dual connectivity is formed by the first radiator and the third radiator.

In an embodiment, the first radiation segment 32 of the first radiator 30 may be configured to transmit and receive the 4G radio-frequency signal; the second radiation segment 33 of the first radiator 30 may be configured to transmit and receive the 5G radio-frequency signal; the second radiator 40 may be configured to receive the 4G radio-frequency signal; and the third radiator 50 may be configured to receive the 5G radio-frequency signal. The respective functions of the first radiation segment 32 and second radiation segment 33 of the first radiator 30, the second radiator 40, and the third radiator 50 can also be adjusted as desired.

In an embodiment, the antenna assembly may further include a fourth radiator 60.

The fourth radiator 60 has a fourth feed point 64. The fourth feed point is configured to be connected to a fourth signal source 65. The fourth radiator 60 is connected to the grounding plane 70 via a fifth connection member.

In this embodiment, the first radiator 30 may be configured to transmit and receive the first low-frequency radio-frequency signal; the second radiator 40 may be configured to transmit and receive the second low-frequency radio-frequency signal, a first medium-frequency radio-frequency signal, and a first high-frequency radio-frequency signal; the third radiator 5 may be configured to transmit and receive a third low-frequency radio-frequency signal; and the fourth radiator 60 may be configured to transmit and receive a second medium-frequency radio-frequency signal and a second high-frequency radio-frequency signal.

The above-described low-, medium-, and high-frequency radio-frequency signals adopt different frequency bands. For example, a low-frequency band may range from 700 MHz to 960 MHz; a medium-frequency band may range from 1,710 MHz to 2,170 MHz; and a high-frequency band may range from 2,300 MHz to 2,690 MHz. It should be noted that the above-mentioned low-, medium-, and high-frequency bands are not limited to any of these examples, and may also transmit signals of other frequency bands.

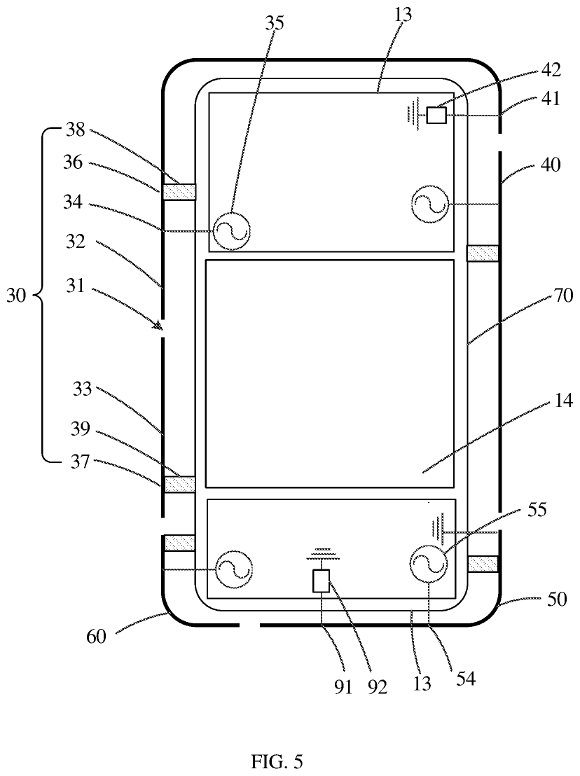

In an embodiment, with reference to FIG. 5, a ground branch may be disposed between the fourth radiator 60 and the third radiator 50. For example, the ground branch is disposed at a position of a ground terminal 91 as illustrated in FIG. 5. A control switch 92 may also be disposed on the ground branch to control a ground state.

It should be noted that a ground branch may also be disposed on the second radiator 40. For example, a gap is defined on the second radiator 40 to divide the second radiator 40 into two radiation segments. These two radiation segments may be grounded via a connection member or a ground branch. As illustrated in FIG. 5, one radiation segment of the second radiator 40 is grounded by being connected to the grounding plane 70 via the connection member, and the other one radiation segment of the second radiator 40 is grounded via the ground branch. A control switch 42 may also be disposed on the above-mentioned ground branch. For example, the ground branch is disposed at the position of the ground terminal 41, and the control switch 42 is disposed on the ground branch.

In an embodiment, the first radiator 30, the second radiator 40, the third radiator 50, and the fourth radiator 60 may each use the metallic frame of the electronic device for radiation. For example, the electronic device includes a rectangular metallic frame. The metallic frame further includes a bottom edge, and two side edges, i.e., a left-side edge and a right-side edge. For example, the first radiator 30 may be disposed on the left-side edge, the fourth radiator 60 and the third radiator 50 may be disposed on the bottom edge, and the second radiator 40 may be disposed on the right-side edge.

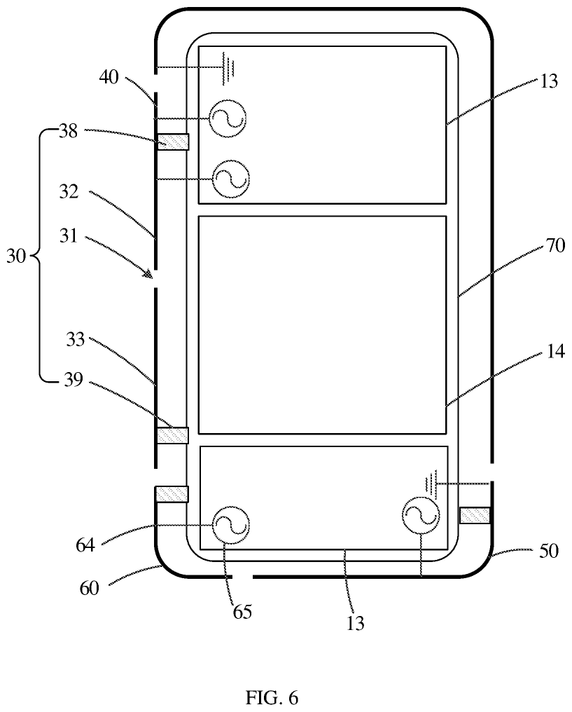

Further referring to FIG. 6, in this embodiment, also, two antenna radiators may be disposed on one side edge of the metallic frame. For example, both the first radiator 30 and the second radiator 40 are disposed on the left-side edge, and the fourth radiator 60 and the third radiator 50 are disposed on the bottom edge. In this embodiment, each of the first radiator 30 and the second radiator 40 includes a gap, and each of the first radiator 30 and the second radiator 40 has a feed point disposed thereon. The signal source is disposed on the feed point. Further, the first radiator 30 has a greater length than the second radiator 40.

In this embodiment, the first radiator 30 and the second radiator 40 may share one ground terminal. For example, the first ground terminal 36 and the second ground terminal 37 are disposed on the first radiator 30, and the first radiator 30 is divided by the second gap 31 into the first radiation segment 32 and the second radiation segment 33. The first ground terminal 36 is located on the end of the first radiation segment 32 facing away from the second gap 31, the second ground terminal 37 is located on the end of the second radiation segment 33 facing away from the second gap 31. The first radiation segment 32 is coupled to the grounding plane 70 at the position of the first ground terminal 36 via the first connection member 38 for grounding. The second radiation segment 33 is coupled to the grounding plane 70 at the position of the second ground terminal 37 via the second connection member 39 for grounding.

For the second radiator 40, similarly, a gap is defined on the second radiator 40 to divide the second radiator 40 into two radiation segments, i.e., an upper radiation segment and a lower radiation segment. The upper radiation segment may be grounded by providing a ground branch. The lower radiation segment may be grounded through coupling between the first connection member 38 and the grounding plane 70. Therefore, in this embodiment, the first radiator 30 and the second radiator 40 are both disposed on the same side of the metallic frame, and they are grounded using the same ground terminal and the same connection member, thereby saving a device space for a design of the entire device and improving a reuse rate.

The antenna assembly provided in the above embodiments supports all current LTE frequency bands and existing LTE re-farming bands NSA/SA, such as N1/3/7/20/28, LB+LB ENDC. In addition, the solution of disposing the first radiator on the side edge to achieve low-frequency double resonances has a high degree of freedom, and reduces interference of the user's limbs with the radio-frequency signal when the user uses the device.

The embodiments of the present disclosure further provide an electronic device. The electronic device includes a housing, and an antenna assembly located inside the housing. The antenna assembly includes a grounding plane, a first radiator, and a first signal source. The first radiator includes a first radiation segment and a second radiation segment that are opposite to each other. A first gap is defined between the first radiator and the grounding plane. A second gap is defined between the first radiation segment and the second radiation segment. The first radiation segment has a first feed point disposed thereon and a first ground terminal disposed on an end thereof facing away from the second gap. The second radiation segment has a second ground terminal disposed on an end thereof facing away from the second gap. The first signal source is connected to the first radiation segment at the first feed point and configured to feed an excitation signal to the first radiator. The excitation signal is configured to: excite a resonance of the first radiation segment in a first low-frequency mode, and excite a resonance of both the second radiation segment and the grounding plane in a second low-frequency mode.

In an embodiment, the housing includes a metallic frame and a housing bottom. The housing bottom is surrounded by the metallic frame to define an accommodation space. The antenna assembly is disposed in the accommodation space. The first radiator is a part of the metallic frame and located on a side edge of the metallic frame.

In an embodiment, the electronic device further includes a bearing plate. The bearing plate is connected to the metallic frame and serves as the grounding plane. A gap between the metallic frame and the bearing plate serves as the first gap.

In an embodiment, the electronic device further includes a battery and a circuit board.

The battery and the circuit board are both disposed on the bearing plate. The second gap is defined on the metallic frame at a position corresponding to the battery. The first signal source is disposed on the circuit board. In an embodiment, as illustrated in FIG. 2, the bearing plate 70 serves as the grounding plane. When the battery 14 is disposed on the bearing plate 70, the first signal source can be designed and disposed on the circuit board 13 above the battery 14 due to a limited area of the bearing plate 70. In addition, the first gap 71 only has a small part corresponding to a position of the circuit board 13, and a large part corresponding to a position of the battery 14. Therefore, the feed is necessarily disposed to be close to the first ground terminal rather than being close to the second gap. That is, the distance between the first feed point 34 and the second gap is greater than the distance between the first feed point 34 and the first ground terminal.

In addition, it should be understood that when the above frame is made of a metallic material, e.g., a magnesium alloy, an aluminum alloy, etc. The metallic frame may be configured to form a system ground, which is an entire device ground of the electronic device 100.

In this embodiment, the above-described electronic device may be a mobile phone, a tablet personal computer, a laptop computer, a personal digital assistant (PDA), a mobile internet device (MID), or a wearable device, etc.

The above are the antenna assembly and the electronic device provided in the embodiments of the present disclosure. The antenna assembly 100 includes the grounding plane, the first radiator, and the first signal source. The first gap is defined between the first radiator and the grounding plane. The first radiator includes the first radiation segment and the second radiation segment that are opposite to each other. The second gap is defined between the first radiation segment and the second radiation segment. The first radiation segment has the first feed point disposed thereon and the first ground terminal disposed on the end thereof facing away from the second gap. The second ground terminal is disposed on the end of the second radiation segment facing away from the second gap. The first signal source is connected to the first radiation segment at the first feed point and configured to feed the excitation signal to the first radiator. The excitation signal is configured to: excite the resonance of the first radiation segment in the first low-frequency mode, and excite the resonance of both the second radiation segment and the grounding plane in the second low-frequency mode. The antenna assembly provided by the embodiments of the present disclosure can simultaneously generate a low-frequency resonance on the first radiation segment and the second radiation segment, thereby effectively improving the radiant performance of an antenna of a device.

The antenna assembly and the electronic device provided by the embodiments of the present disclosure are described in detail above. Specific examples are provided herein to describe the principles and implementations of the present disclosure. The above-described embodiments are merely intended to facilitate understanding of the present disclosure. Meanwhile, those skilled in the art can make changes to the specific implementations and the application scope based on the concepts of the present disclosure. To sum up, the content of the specification shall not be construed as a limitation to the present disclosure.

What is claimed is:

1. An antenna assembly, comprising:
a grounding plane;
a first radiator comprising a first radiation segment and a second radiation segment that are opposite to each other, a first gap being defined between the first radiator and the grounding plane, a second gap being defined between the first radiation segment and the second radiation segment, the first radiation segment having a first feed point and a first ground terminal disposed on an end of the first radiation segment facing away from the second gap, and the second radiation segment having a second ground terminal disposed on an end of the second radiation segment facing away from the second gap; and
a first signal source connected to the first radiation segment at the first feed point and configured to feed an excitation signal to the first radiator, the excitation signal being configured to: excite a resonance of the first radiation segment in a first low-frequency mode, and excite a resonance of both the second radiation segment and the grounding plane in a second low-frequency mode.

2. The antenna assembly according to claim 1, wherein a distance between the first feed point and the second gap is greater than a distance between the first feed point and the first ground terminal.

3. The antenna assembly according to claim 1, further comprising:
a circuit board;
a first connection member; and
a second connection member, wherein:
the first signal source is disposed on the circuit board;
the first radiation segment is connected to the grounding plane at a position of the first ground terminal via the first connection member; and
the second radiation segment is connected to the grounding plane at a position of the second ground terminal via the second connection member.

4. The antenna assembly according to claim 3, wherein:
the first low-frequency mode is an inverted-F antenna resonance mode; and
the second low-frequency mode is a loop antenna mode.

5. The antenna assembly according to claim 4, wherein:
the first low-frequency mode is generated by an excitation of the first signal source through a path via the first radiation segment and the first connection member; and
the second low-frequency mode is generated by an excitation of the first signal source through a path via the circuit board, the second connection member, and the second radiation segment.

6. The antenna assembly according to claim 5, wherein the second low-frequency mode is generated by an electric field excitation at an end of the first radiation segment close to the second gap.

7. The antenna assembly according to claim 5, wherein in a current path of the second low-frequency mode, a current is oriented to flow from the second ground terminal to the second gap through the second radiation segment.

8. The antenna assembly according to claim 1, further comprising:
a second radiator provided with a second feed point and connected to the grounding plane via a third connection member; and
a second signal source configured to feed an excitation signal to the second radiator to excite a resonance of the second radiator in a third low-frequency mode.

9. The antenna assembly according to claim 8, wherein:
the first radiator is configured to transmit and receive a first low-frequency radio-frequency signal; and
the second radiator is configured to receive a second low-frequency radio-frequency signal.

10. The antenna assembly according to claim 8, wherein:
the first radiation segment of the first radiator is configured to transmit and receive a 4-th Generation Mobile Communication Technology (4G) radio-frequency signal;
the second radiation segment of the first radiator is configured to transmit and receive a 5-th Generation Mobile Communication Technology (5G) radio-frequency signal; and
the second radiator is configured to receive the 4G radio-frequency signal and the 5G radio-frequency signal.

11. The antenna assembly according to claim 8, further comprising:
a third radiator provided with a third feed point and connected to the grounding plane via a fourth connection member; and
a third signal source, the third feed point being connected to the third signal source.

12. The antenna assembly according to claim 11, wherein:
the first radiator is configured to transmit and receive a first low-frequency radio-frequency signal;
the second radiator is configured to receive a second low-frequency radio-frequency signal; and
the third radiator is configured to receive a third low-frequency radio-frequency signal.

13. The antenna assembly according to claim 12, wherein:
the first radiation segment of the first radiator is configured to transmit and receive a 4G radio-frequency signal;
the second radiation segment of the first radiator is configured to transmit and receive a 5G radio-frequency signal; and
the second radiator or the third radiator is configured to receive the 4G radio-frequency signal and the 5G radio-frequency signal.

14. The antenna assembly according to claim 12, wherein:
the first radiation segment of the first radiator is configured to transmit and receive a 4G radio-frequency signal;
the second radiation segment of the first radiator is configured to transmit and receive a 5G radio-frequency signal;
the second radiator is configured to receive the 4G radio-frequency signal; and
the third radiator is configured to receive the 5G radio-frequency signal.

15. The antenna assembly according to claim 11, further comprising:
a fourth radiator provided with a fourth feed point and connected to the grounding plane via a fifth connection member; and
a fourth signal source, the fourth feed point being connected to the fourth signal source.

16. The antenna assembly according to claim 15, wherein:
the first radiator is configured to transmit and receive a first low-frequency radio-frequency signal;
the second radiator is configured to transmit and receive a second low-frequency radio-frequency signal, a first medium-frequency radio-frequency signal, and a first high-frequency radio-frequency signal;
the third radiator is configured to transmit and receive a third low-frequency radio-frequency signal; and
the fourth radiator is configured to transmit and receive a second medium-frequency radio-frequency signal and a second high-frequency radio-frequency signal.

17. An electronic device, comprising:
a housing; and
an antenna assembly located inside the housing, the antenna assembly comprising:
a grounding plane;
a first radiator comprising a first radiation segment and a second radiation segment that are opposite to each other, a first gap being defined between the first radiator and the grounding plane, a second gap being defined between the first radiation segment and the second radiation segment, the first radiation segment having a first feed point and a first ground terminal disposed on an end of the first radiation segment facing away from the second gap, and the second radiation segment having a second ground terminal disposed on an end of the second radiation segment facing away from the second gap; and
a first signal source connected to the first radiation segment at the first feed point and configured to feed an excitation signal to the first radiator, the excitation signal being configured to: excite a resonance of the first radiation segment in a first low-frequency mode, and excite a resonance of both the second radiation segment and the grounding plane in a second low-frequency mode.

18. The electronic device according to claim 17, wherein the antenna assembly further comprising:
a second radiator provided with a second feed point and connected to the grounding plane via a third connection member; and
a second signal source, configured to feed an excitation signal to the second radiator to excite a resonance of the second radiator in a third low-frequency mode.

19. The electronic device according to claim 18, wherein the first low-frequency mode, the second low-frequency mode and the third low-frequency mode are configured to support LB+LB ENDC combination of 4G and 5G communication.

20. The electronic device according to claim 19, wherein
the first low-frequency mode is configured to support a transmission and reception of a 4G radio-frequency signal,
the second low-frequency mode is configured to support a transmission and reception of a 5G radio-frequency signal, and
the third low-frequency mode is configured to support a reception of the 4G radio-frequency signal and the 5G radio-frequency signal.
